(19) United States
(12) Patent Application Publication
(10) Pub. No.: US 2008/0041453 A1
(43) Pub. Date: Feb. 21, 2008

(54) Microfluidic Testing System

(75) Inventor: Reinhold Wimberger-Friedl, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,531

(22) PCT Filed: Sep. 28, 2005
(86) PCT No.: PCT/IB05/53196

§ 371 Date: Apr. 3, 2007

(30) Foreign Application Priority Data
Oct. 6, 2004 (EP) 04104900.8

(51) Int. Cl. F17D 1/16

(52) U.S. Cl. 137/13

(57) ABSTRACT

The invention relates to a testing system comprising a fluid container (10) and an optical system (30) for the investigation of fluid samples. The fluid container (10) is provided with microchannels (13, 14) that contain and guide sample fluid. Active elements (1), particularly consisting of a hydrogel mixed with a light absorbing dye, are disposed in said microchannels. The active elements can be transferred from a non-activated state to an activated state with a different shape by a laser beam (35). This can be used to design micro valves and/or pumps. The laser beam (35) is preferably generated by an optical system (30) that is derived from the reading/writing unit of a Compact Disc player.

The invention relates to a fluid container with microchannels and a testing system comprising such a container for the examination of a fluid.

The examination of small samples in integrated platforms is becoming increasingly important in biology and medicine. Such platforms typically have microchannels which contain and guide fluid components that shall be processed, e.g. transported, reacted or measured. From the U.S. Pat. No. 6,030,581 a testing platform is known that is integrated in a Compact Disc (CD) like device and that comprises different means to manipulate a sample fluid. Said testing platform may particularly comprise valves with metal foils which require an integrated wiring for switching by electrical voltages.

Based on this situation it was an object of the present invention to provide means for the examination of small samples of fluids that are reliable in their use and that can be produced in a cost-effective way.

This object is achieved by a fluid container according to claim 1 and a testing system for fluids according to claim 8. Preferred embodiments are disclosed in the dependent claims.

A fluid container according to the present invention comprises microchannels that contain and guide (gaseous or liquid) fluids which shall be processed and/or examined. The term “microchannels” shall indicate a miniaturization of the fluid container which allows the analysis of tiny samples. The microchannels typically are rectangular with a height ranging from 1 to 1000 μm, preferably from 10 to 100 μm, wherein the width of the channels is a less critical design parameter that may typically range from 1 to 1000 μm. According to the invention, at least one “active element” is disposed in at least one of the microchannels at a fixed place in such a way that it can be reached by a light beam coming from a light source which may be internal or external with respect to the fluid container. The wavelength of the (mono- or polychromatic) light beam typically lies in the range from 350 nm to 850 nm, though other wavelengths (e.g. of infrared) may be applied if useful, too. The active element may by definition be transferred from a non-activated to an activated state by the effect of light, wherein the active element shall assume different shapes in the “non-activated state” and in the “activated state”, respectively. The term “shape” shall refer to both form and dimension here, such that e.g. two spheres of different diameter are considered as having different shape. Different shapes may particularly be associated with a difference of volumes and/or of extensions in at least one direction, said difference preferably being larger than 5%, most preferably larger than 20% (with respect to the smaller volume/extension). Thus the difference is significantly larger than that associated with usual heat expansion that is experienced by every material due to heating. The consistency of the active element as a whole shall be non-liquid in both the activated and non-activated state, such that the active element assumes a more or less defined shape in these states.

A fluid container of the aforementioned kind can be produced rather cost-effective because it does not require any electrical equipment or wiring. Instead, control elements for fluid flow like valves or pumps can simply be realized by active elements of an appropriate material that are accessible to a light beam. The light beam may for example be produced by an optical system similar to the reading/writing devices of Compact Disc players. This has the advantage that many available components can be used and that the fluid container can be controlled without direct mechanical contact. Moreover, the light source can often be used for other purposes, too, e.g. for a optical analysis of the sample.

A variety of different realizations are possible for an active element that changes its shape under the effect of light. According to a preferred embodiment, the active element comprises a material (e.g. a wax) that undergoes a phase transition in a temperature range of about 10° C. to about 80° C., most preferably of about 30° C. to about 40° C., if heat is added to the material or removed from it. In this case a change of volume that is associated with a physical phase transition of a suited material is exploited, and the active element therefore does not need to be structured in a complicated way but may simply be some quantity or mass of material. The phase transitions may for example be one of the transitions between solid, liquid and gaseous phases and/or between different types of solid phases (crystal structures).

In a preferred realization of the invention, the active element comprises a gel, particularly a hydrogel with an upper-critical solution temperature. Such hydrogels dissolve and swell in a solvent, for example in water, at low temperatures, but phase separate at elevated temperatures, i.e. the solvent moves out and the gel collapses. The associated volume changes of such gels may be up to 200% or more. The gel may optionally have a structured design with an enlarged surface area in order to improve the reaction speed and to accelerate diffusion processes.

In a further development of the aforementioned embodiment, the active element comprises a converting material that converts absorbed light into heat. Said converting material may be heterogeneously or homogeneously mixed with or chemically bound to the gel which has the advantage that light is absorbed throughout the whole active element yielding a fast and uniform transition. Alternatively, the converting material may be disposed separately from the gel, optionally even separated from it by an intermediate protection layer, in which case heat generated in the converting material has to be conducted into the gel.

The change of shape of the active element can be used for an efficient control of fluid flow in the fluid container. The active element may for example be disposed in a microchannel such that it blocks said microchannel in its expanded state. Thus, the active element serves as a valve that selectively allows or interrupts fluid flow through a microchannel.

According to another application in flow control, the active element is disposed along at least one wall of a microchannel in such a way that it drives fluid out of said microchannel in its expanded state. The active element may additionally block the microchannel in its expanded state or not. More important is in this case the effect that some amount of fluid is expelled from the volume of the microchannel such that the active element serves as a pump.

The microchannels of the fluid container may at least partially be covered by a transparent material, for example glass or transparent plastics. An active element that is disposed in such a microchannel may then easily be reached by a light beam in order to initiate a desired transition to an activated state.

The invention further relates to a testing system for fluids (particularly for small amounts of fluid with a typical volume in the order of 100 nl to 1000 μl), comprising the following components:
A fluid container of the kind described above, i.e. with microchannels in which at least one active element is disposed reachable by a light beam, wherein said active element can be transferred into an activated state of different shape by light.
An optical system for selectively irradiating active elements of said fluid container with a light beam.

The aforementioned testing system provides a complete arrangement for the manipulation of samples in a fluid container of the kind described above. In this case, the active elements of the fluid container are controlled by light that is generated in the optical system, i.e. externally of the fluid container. Therefore, the fluid container can be kept as simple as possible, e.g. only comprising the microchannels, the active elements and the sample. Of course all special embodiments of the fluid container that were described above may be used in connection with the testing system. Therefore, reference is made to the preceding description for more information on the details, advantages and improvements of the testing system.

In a further development of the testing system, the optical system comprises a controller that is adapted to control location, intensity and/or duration of the light beam according to the desired effects on the active elements. If an active element for example serves as a valve in a microchannel and said valve shall be kept open for a certain time, the light beam must guarantee this and for example deliver enough energy to maintain a phase transition in a hydrogel and to compensate cooling effects of flowing fluids.

Furthermore, the optical system may comprise means for scanning an area inside the fluid container with a focused laser beam. Such means may particularly be derived from the reading and/or writing units of a Compact Disc players. The scanning and focusing of a laser beam has the advantage that only one light source has to be provided for the control of a plurality of active elements. The scanning can normally be done fast enough to switch a large number of active elements practically simultaneously due to the inertia of the thermal processes in the active elements.

According to another embodiment of the invention, the optical system of the testing system may be adapted to perform an optical processing of the sample. It may for example be able to generate and guide a light beam into the sample that can start certain processes there, e.g. chemical reactions or the stimulation of fluorescence. Moreover, the optical system may be adapted to collect (reflected, transmitted, luminescent, . . . ) light emerging from the sample for measurements of optical characteristics of the sample.

These and other aspects of the invention will be apparent from and elucidated with reference to the embodiment(s) described hereinafter.

In the following the invention is described by way of example with the help of the accompanying drawings in which:

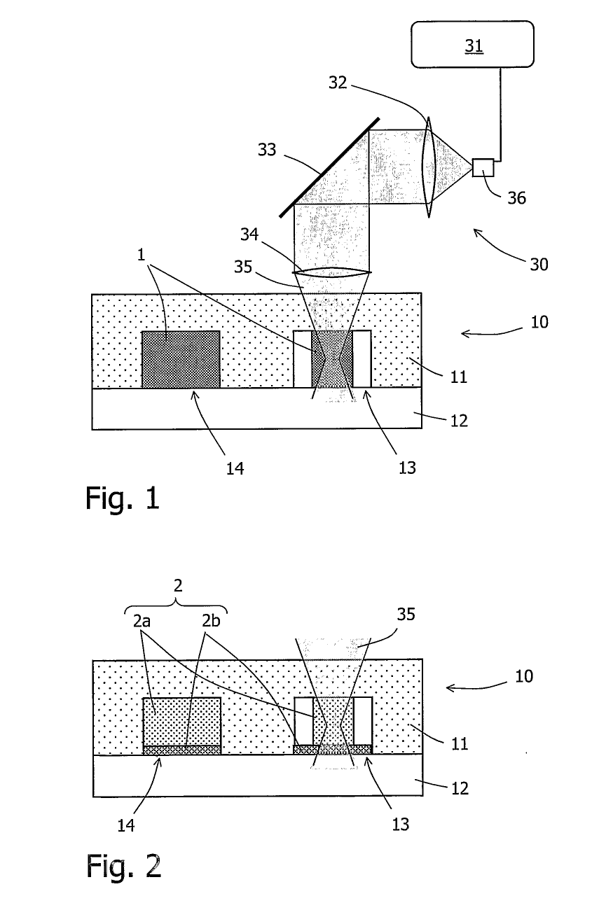

FIG. 1 shows a principle sketch of a testing system according to the present invention with a hydrogel that is mixed with an absorbing dye;

FIG. 2 shows an alternative embodiment of the fluid container of FIG. 1 with a separate layer of a converting material;

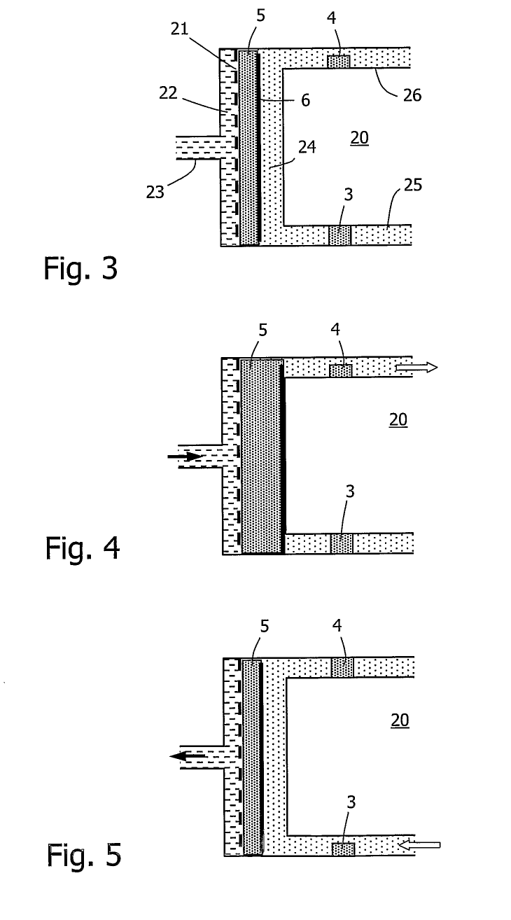

FIG. 3-5 show three consecutive stages of the application of active elements according to the present invention for pumping and guiding a fluid.

The analysis of biological samples on integrated miniaturized fluidic platforms like the fluid container 10 is of increasing importance in medical care and pharmacological development. The success of this technology in practice is however strongly dependent on the reliability, ease of operation and low cost of such devices. Hand-held disposable cartridges inserted in a reader need to carry out a complex sequence of steps for the preparation, mixing, filtering, splitting and measuring of samples and internal standards, etc. depending on the type of biological assay and type of detection. This sequence of steps requires the precise manipulation of liquid volumes in microscopic channels.

There are many approaches which have been proposed for this purpose. A first category of approaches is the so-called passive fluidic devices. Passive devices make use of external mechanical forces, like a push-pin with a membrane, a fluid pump, centrifugal force or compressed air (pneumatic actuation). Passive devices suffer from limited functionality and a vulnerable interface. The mechanical and/or fluidic interface between cartridge and reader in such systems requires high precision and certainly maintenance.

A second category are active devices in which the fluidic actuation is achieved on the cartridge without “mechanical” interface, but rather an electrical interface. The electrical signal and energy is then transformed into a movement of the liquid itself (electrophoresis) or channel walls (like in MEMS devices). Active devices with electro-mechanical actuation require MEMS (Micro-Electromechanical-Systems) technology, based on relatively expensive substrates. Apart from the cost also the reliability and proper functioning of valves and pumps is still an issue (like the requirements of no dead volume, no leakage flow in the off state, etc.).

Various embodiments of a testing system proposed here that are both reliable and cost-effective are shown in the Figures. FIG. 1 depicts diagrammatically a section through a part of a fluid container 10 and the associated optical system 30 for the examination of biological, chemical, biochemical or other liquid or gaseous fluids. The fluid container 10 basically consist of a substrate 12, for example a glass plate, upon which a micro-structured lid 11 of a transparent material, for example plastics, is disposed. Said micro-structured lid 11 comprises microchannels 13, 14 (two of which are shown in FIG. 1 in a section) and which contain and guide the fluid to be examined in the container 10.

Furthermore, “active elements” 1 are disposed in the microchannels 13, 14 that can change their volume under the influence of a light beam 35 and that can thus control the movement of the fluid through the microchannels 13, 14. In the left microchannel 14 of FIG. 1, such an active element 1 is shown in its expanded or “non-activated” state in which it assumes a larger volume and therefore blocks the microchannel 14 and interrupts any fluid flow. In the right microchannel 13, the active element 1 is in its shrunk “activated state” in which it occupies are smaller volume and thus leaves room for the passage of fluid through this microchannel 13. The movement of the active element 1 under expansion or shrinkage can be influenced by providing a locally different adhesion to the walls of the microchannels 13, 14, i.e. areas with a high adhesion will remain at their place while areas with a lower adhesion will be able to move with respect to the inner walls of the microchannels.

The active elements 1 may particularly comprise a responsive gel. Polymer gels can respond to a change in the environment by a change in dimensions, as a consequence of a changed solubility in (typically) water. The stimulus from the environment can be the pH, electrical charge or temperature. Gels with an upper-critical solution temperature (UCST) dissolve (and swell) very well in a solvent at low temperature but phase separate at elevated temperatures (cf. C. Yu et al., Anal. Chem. 2003, web ed. http://dx.doi.org/10.1021/ac026455j). The volume change of such gel systems is extremely large (>200%). Furthermore, the US 2004/0050436 A1 describes the use of polymers which can be transformed from a liquid-like state (“sol”) to a solid-like state (“gel”) by heat induced cross-linking, wherein said polymers shall be added as a sol to a sample liquid and selectively transformed to a gel if a microchannel is to be blocked.

Moreover, the active element 1 comprises a “converting material” or dye which absorbs at the wavelength of the laser radiation (e.g. 785 nm, like in CD-R or 650 nm like for DVD-R) and converts absorbed light into heat. The dye may be added (homogeneously) to the hydrogel during preparation.

In the upper part of FIG. 1, an optical system 30 for the generation of a laser beam 35 is schematically shown. The optical system 30 comprises a light source 36 that generates a divergent laser beam. Said laser beam is collimated by a first lens (or set of lenses) 32, reflected by a mirror 33, and focused into the container 10 by an objective 34. The optical system 30 is adjusted such that the focus of the laser beam 35 lies within the active element 1 of microchannel 13 which shall assume its activated (shrunk) state. The whole optical system 30 or at least a part of it, for example the mirror 33 with the objective 34, is preferably movable such that a larger area of the fluid container 10 can be scanned. An optical system 30 with corresponding features may particularly be derived from the reading/writing units of a Compact Disc player or recorder. Moreover, the optical system may simultaneously be adapted to perform a processing and/or an analysis of the sample, for example to measure absorption or fluorescence characteristics.

FIG. 2 shows an alternative embodiment of the fluid container 10. Components that are identical to those of FIG. 1 are indicated with the same reference signs and will not be explained again. In contrast to FIG. 1, the active elements 2 in the microchannels 13, 14 now consist of a pure hydrogel block 2a and a separate layer of converting material 2b. Said layer of converting material 2b is disposed below the hydrogel 2a with respect to the direction of the incident light beam 35. The converting layer 2b may consist of the same dyes as were used in a system according to FIG. 1 in a mixture with the hydrogel.

While FIGS. 1 and 2 show an arrangement with a transmission of the laser beam 35, it is also possible to work with a reflective arrangement. In this case, the upper surface of the substrate 12 might for example be provided with a reflective coating that reflects the laser light back into the active element. Furthermore, laser light leaving the container 10 (whether in transmission or reflection) may optionally be analyzed to provide information about the active element and/or the sample fluid.

Moreover, it is of course also possible to use more than one light source (e.g. an array of lasers) in order to irradiate several or even all of the active elements independently and simultaneously.

A central aspect of the proposed system is the use of a focused and actuated laser beam 35 as heat source for the manipulation of liquid on microfluidic platforms. The laser and its manipulation system comprises a set-up which is essential like a pick-up used for optical data storage, like CD-R, with the important difference that the substrate is not rotating but a resting fluid container 10.

During operation of the device shown in FIG. 1 or 2, the laser beam 35 is scanning the fluid container or cartridge 10 and the laser power is modulated in time such that the required power is delivered at the required positions. As already mentioned, the absorption of the power is achieved by the addition of a dye to the hydrogel during preparation (FIG. 1), or alternatively in a thin polymer layer 2b underneath the hydrogel 2a (FIG. 2). Upon irradiation the light 35 will be transformed into heat which will lead to the collapse of the hydrogel. Since the actuation of the laser beam 35 can be very fast compared to the heat conduction it is possible to heat several positions quasi-simultaneously. In the case that the hydrogel blocks a channel in the cold state and opens it upon heating it can operate as a valve (FIGS. 1, 2). By the correct concerted action of a set of such valves the routing of the liquid can be adjusted real time to the purpose. By a different operation of a system of valves a peristaltic pump action can be achieved. The response time of the system is adjusted via the dimensions of the gel structure and the focus and power control of the laser.

In the following, a concrete example of a testing system will be described in more detail. In this example, poly-NIPAA (N-isopropyl-acrylamide) is used as a hydrogel. The reliable switching of poly-NIPAA in water requires the switching from room temperature to about 40° C., i.e. 20° C. temperature rise. The heat capacity of such a gel is almost equal to that of water, i.e. 4 kJ/kgK. The volume which is addressed depends on the time scale in the case of a stationary beam. In any case the heat penetration should be in the order of the height of the valve in order to achieve a homogeneous temperature distribution. With a heat diffusivity of approximately 2·10⁻⁷ a penetration of 50 μm is achieved in 5 ms. The power required to heat 50 μm³ in 5 ms by 20° C. is 2 mW which can easily be absorbed from a diode laser as used in optical storage. As soon as the gel 1 or 2a (FIG. 1, 2) contracts the fluid can pass. It will start cooling the gel. Therefore the power of the laser will have to be modulated to maintain that temperature but without overheating. Such power control may be provided by the controller 31 that is indicated in FIG. 1 and that may for example be implemented by a microprocessor. The power of the laser source 36 will determine the number of valves which can be activated at the same time (e.g. with 50 mW this would be 25 valves, which can be sufficient for a complete analysis on a cartridge.)

Next to polyNIPAA there are more materials with UCST behavior which can be used. As absorbing dye the standard CD-R dye can be used which is water soluble, but it has to be attached to the gel network to avoid contamination of the biological sample. This can be achieved by attaching a reactive group, like an acrylate group to the dye and copolymerizing it with the gel. In the case of a separate converting or “heating” layer 2b underneath the gel 2a (see FIG. 2), a thin barrier layer in between the converting layer 2b and the swelling layer 2a can optionally be provided (not shown) in order to prevent the flow of any substance from one layer to the other.

FIGS. 3 to 5 show a top view of a part of a fluid container 20 with microchannels 22-24 in which active elements 3-5 are disposed as valves or pumps, respectively.

FIG. 3 shows the first operating stage of said fluid container 20, in which a valve 3 is expanded (i.e. non-activated in case of hydrogels) such that the corresponding lower right channel 25 is closed, while another valve 4 is shrunk to open the upper right channel 26. Moreover, an active element 5 or “pumping element” that is disposed on a permeable wall 21 (e.g. a membrane) is in its shrunk state (i.e. activated by a laser beam in case of a hydrogel). The pumping element 5 is covered on its right side, which forms a boundary of a chamber 24 with the sample fluid, with a watertight coating 6 in order to prevent a fluid exchange between the pumping element and the sample. On its left side, the pumping element 5 is however open to exchange water with a chamber 22 that is adjacent to the wall 21 and linked via a channel 23 to a water reservoir (not shown). Thus the pumping element 5 can take up or expel water through the wall 21 during swelling and shrinking, respectively.

FIG. 4 shows the next stage of operation in the fluid container 20, in which the pumping element 5 has been transferred into its expanded state, a process which is accompanied by an uptake of water from the reservoir through the wall 21. The pumping element 7 therefore drives the sample fluid out of chamber 24 into the upper channel 26 connected thereto.

In FIG. 5, valve 4 is closed while valve 3 is opened (e.g. by irradiation with light). Furthermore, the pumping element 7 is in its shrunk state again, thus sucking sample fluid through the lower channel 25 into the chamber 24 while driving its internal water back through the wall 21 into the reservoir. FIGS. 3 to 6 show that valves 3, 4 can be combined to achieve a pumping action and that channel walls covered with the thermo-responsive gel 5 can be used to make a peristaltic movement and create a sample flow.

In summary, the control of the flow in microchannels is an essential part of a miniaturized sensor for analyzing biological and/or chemical samples. The selective detection of for instance proteins in a biological sample requires a sequence of flow-controlled actions and interactions which can only be achieved with the aid of valves. Instead of passive valves which are inflexible and electro-mechanical valves which are expensive to make and less reliable, it is proposed to use thermally activated valves of polymeric gels with an upper-critical solution temperature in water. The thermal activation, i.e. temperature change is achieved by absorption of laser radiation by the inclusion of a dye in the hydrogel. By fast actuation/scanning of the laser with optically controlled positioning multiple valves can be addressed quasi-simultaneously. In this way the fluidic action can be adopted during the execution of a certain analysis. The required laser action can be achieved with a CD-R or DVD-R pick-up. The described system can be implemented readily on all-plastic substrates in combination with a micro-fluidic channel system by photo-lithographic or other structuring technology and in this way enable very low cost cartridges with a robust all optical interface very similar to CD technology.

Finally it is pointed out that in the present application the term “comprising” does not exclude other elements or steps, that “a” or “an” does not exclude a plurality, and that a single processor or other unit may fulfill the functions of several means. Moreover, reference signs in the claims shall not be construed as limiting their scope.

1. Fluid container (10, 20) with microchannels (13, 14, 22-26) in which at least one active element (1-5) is disposed reachable by a light beam (35), wherein said active element (1-5) can be transferred into an activated state of different shape by irradiation with light (35).

2. The fluid container (10, 20) according to claim 1, characterized in that the active element has a different extension in at least one direction and/or a different volume in its activated state.

3. The fluid container (10, 20) according to claim 1, characterized in that the active element comprises a gel (1, 2a, 3-5).

4. The fluid container (10, 20) according to claim 3, characterized in that the active element comprises a converting material (2b) that converts absorbed light (35) into heat.

5. The fluid container (10, 20) according to claim 1, characterized in that the active element (1-5) is disposed such that it blocks the microchannel (13, 14, 25, 26) either in its activated or in its non-activated state.

6. The fluid container (10, 20) according to claim 1, characterized in that the active element (5) is disposed along a wall (21) of a microchannel (24) such that it drives fluid out of said microchannel (24) during the transition from its activated to its non-activated state or vice versa.

7. The fluid container (10, 20) according to claim 1, characterized in that the microchannels (13, 14, 22-26) are at least partially covered by a transparent material.

8. Testing system for fluids, comprising:
a fluid container (10, 20) with microchannels (13, 14, 22-26) in which at least one active element (1-5) it is disposed reachable by a light beam (35), wherein said active element (1-5) can be transferred into an activated state of different shape by irradiation with light (35);
an optical system (30) for selectively irradiating active elements (1-5) of said fluid container (10, 20) with a light beam (35).

9. The testing system according to claim 8, characterized in that the optical system (30) comprises a controller (31) that is adapted to control location, intensity and/or duration of the light beam (35) according to the desired effects on the active elements (1-5).

10. The testing system according to claim 8, characterized in that the optical system (30) comprises means for scanning an area inside the fluid container (10, 20) with a focused laser beam (35).

11. The testing system according to claim 8, characterized in that the optical system (30) is adapted to perform an optical processing of the sample.
